(19) United States
(12) Patent Application Publication
(10) Pub. No.: US 2007/0058066 A1
(43) Pub. Date: Mar. 15, 2007

(54) MODULE FOR INCREASING TOTAL TRACK

(76) Inventors: Chuan-Yu Hsu, Hsinchu (TW); Chih-Wen Huang, Hsinchu (TW); Chien-Liang Yeh, Hsinchu (TW)

Correspondence Address: BERKELEY LAW & TECHNOLOGY GROUP, 1700NW 167TH PLACE, SUITE 240, BEAVERTON, OR, 97006, US

(21) Appl. No.: 11/468,912

(22) Filed: Aug. 31, 2006

Related U.S. Application Data
(63) Continuation of application No. 10/041,315, filed on Jan. 8, 2002.

(51) Int. Cl. G02B 13/16

(52) U.S. Cl. 348/335

(57) ABSTRACT

The present invention is a module for increasing total track, especially an application to an optical capturing device, thus the module for increasing total track may change its total track without re-laying out reflection positions and space in said optical capturing device; there are plural kinds of modules to be designed for different total tracks in the present invention, and said modules can be easily and fast substituted in the optical capturing device. The present invention is based on a theory of an incident angle equal to an ejective angle, thus a merge point can be predetermined by an incident light path and an ejective light path; aforesaid phenomenon is not only suitable an one-time reflection, but also plural reflections, and it can be applied in a module with either one reflection element or plural reflection elements.

### FIELD OF THE INVENTION

The present invention is a module for increasing total track, especially an application to an optical capturing device, thus the module for increasing total track may change its total track without re-laying out reflection positions and space in said optical capturing device; there are plural kinds of modules to be designed for different total tracks in the present invention, and said modules can be easily and fast substituted in the optical capturing device.

### BACKGROUND OF THE INVENTION

As some optical image capturing apparatuses, scanners, copy machines, high solution fax machines, cameras and video cameras, a basic theory for scanning is that a light source lights on a scanned object, a reflected or transmitted light from the scanned object then goes through a lens and focuses on an image formation device, such as CCD (Charge Couple Device) or film.

Generally, as said optical image capturing apparatuses needs a track apparatus to reflect or refract said light from the scanned object, thus the light marches a suitable distance (or called light track) to be focused and formed said image formation device for a result of clear image.

Please refer to FIG. 1, which is a prior art of an optical reflection apparatus of a scanner mount. A document side 1 of a loading glass 2 loads a scanned object, a down light 3 lights a light track 1a upward and an image light track 1b is then generated to a mirror 4, an image light track 1c reflects to a mirror 5, thus plural light tracks 1d, 1e and 1f reflect between said mirror 5 and a mirror 6. A light track 1g penetrates a lens 7 and then a light track 1h lights and forms an image in an image sensor 8 (CCD). A scanner mount 9 has a certain space, thus there are two methods to increase total tracks, one of them is to change plural dimensions of said scanner mount 9 for extending total tracks, but the method is not involved a scope of the present invention; another is to increase numbers of reflection to approach a purpose of extending total tracks. FIG. 1 is one of representations of increasing reflection times, and the mirrors 5 and 6 are enlarged for a condition of increased reflection times, thus a cost of enlarged dimensions of mirrors is greater than before.

Please refer to FIG. 2, which is another prior art of an optical reflection apparatus of a scanner mount. A document side 1 of a loading glass 2 loads a scanned object, a down light 3 lights a light track 2a upward and an image light track 2b is then generated to a mirror 4, an image light track 2c reflects to a mirror 5, thus a light track 2d reflects to a mirror 6 and a light track 2e reflects to a mirror 10. A light track 2f penetrates a lens 7 and then a light track 2g lights and forms an image in an image sensor 8. FIG. 2 is another embodiment of increasing reflection times, which is to increase a number of those reflection elements, thus a cost of increasing the number of reflection elements is raised as well.

The prior optical reflection apparatus comprises plural mirrors (three or four as usual), and relevant positions and angles among mirrors are considered when assembling, once a position or an angle of one mirror of them is not accurate, followed light tracks and distances of mirrors are then affected. Especially, the position or the angle of said mirror 4 (the first mirror of reflecting light) is not proper, or a working or positioning device is not accurate, an effect of tolerance accumulation highly decreases image quality.

For an optical reflection apparatus of bigger scanning dimensions, which total track is extended comparatively? Traditionally, the most common methods to approach total track are: enlarging distances of mirrors and adding reflection times of light. However, to enlarge distances is to directly make an optical reflection apparatus bigger and not economical, more, the method does not follow a tendency of smaller electronic products; to add reflection times is to increase both the numbers of mirrors and a weight of the optical reflection apparatus, further, more cost is generated by more mirror assembly and position adjustment. Another point, which is that the effect of tolerance accumulation is proportional to the number of mirror increased. On the other hand, more light refracted in and out mirrors causes serious diffusion and light decayed phenomena to affect scanning quality.

Please refer to FIG. 3, which is the third prior art of an optical reflection apparatus of a scanner mount. The figure shows a prism and is an embodiment of increasing reflection times in a limited space. A light source 11 lights a light track downward to penetrate a loading glass 2 and then to a first reflection mirror 12 of said prism; said light track continuously goes to a second reflection mirror 13 and out of the prism. An important shortcoming for the embodiment, which is that any prism can only fit with a single reflection path, therefore a light reflection path (including reflection times and total track inside said prism) is both not flexible and adjusted after reflection mirrors and positions being positioned. For different scanning products of different total tracks as different scanning dimensions or different solutions, said prism needs to be redesigned for different conditions, such as mentioned above; and another situation is also happened, which is that parts are nor regular and in a module, thus costs of design, manufacturing and storing are raised.

Based on the aforesaid issues, the present inventor of the patent has being studied and referred to practical experiences and theory for designing and effectively improving the prior arts.

### SUMMARY OF THE INVENTION

The first object is to offer a module for increasing total track for applications of different total tracks with different modules within limited spaces. Modules of the present invention are easily instead of any other module for promoting efficiency, and said modules are available to different total tracks, thus there is no need to design new total track systems for different conditions to low down costs. On the other hand, an adjustment of position of lighting into an optical capturing device can approach the purposes of modulating reflection times and total tracks, therefore to design new optical capturing device is no longer existed, this is to benefit parts modulated, decrease parts developing cost and low down storing cost.

The second object is to offer a module for increasing total track to greatly diminish a number of reflection mirrors under a condition of a same total track, low down assembly cost, eliminate tolerance accumulation of reflection angles and reduce total reflection volume.

The third object is to offer a module for increasing total track, which is applied to different total tracks and solutions without changing an original document position and an image scanning position. The module use multiple reflection times to increase total track for reaching above object.

The appended drawings will provide further illustration of the present invention, together with description; serve to explain the principles of the invention.

### BRIEF DESCRIPTION OF THE DRAWINGS

FIG. 1 is a prior art of an optical reflection apparatus of a scanner mount.

FIG. 2 is another prior art of an optical reflection apparatus of a scanner mount.

FIG. 3 is the third prior art of an optical reflection apparatus of a scanner mount.

FIG. 4 is the first illustration of technical theory of the present invention.

FIG. 5 is the second illustration of technical theory of the present invention.

FIG. 6 is a preferred embodiment of a single mirror module of the present invention.

FIG. 7 is a 3-D illustration of a single mirror module of the present invention.

FIG. 8 is a preferred embodiment of a 3-mirror module of the present invention.

FIG. 9 is a 3-D illustration of a 3-mirror module of the present invention.

FIG. 10 is a preferred embodiment of a 4-mirror module of the present invention.

FIG. 11 is a preferred embodiment of a round mirror module of the present invention.

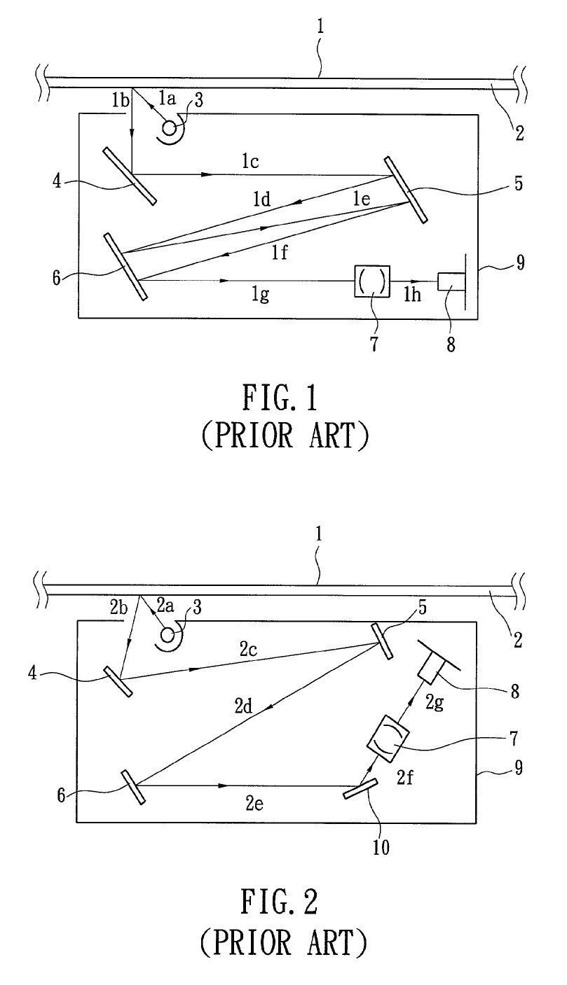

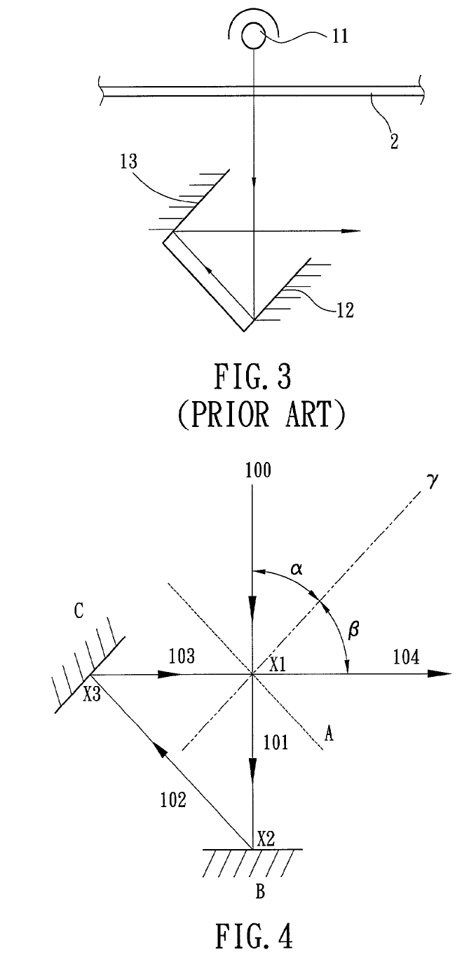

### DETAILED DESCRIPTION OF THE PREFERRED EMBODIMENTS

The present invention comprises an optical capturing device, which including a light source, a lens, plural reflection mirrors and an image sensor (CCD); said light source generates a light to a module for increasing total track for at least one time of reflection, said lens focuses and forms said light on an image formation device; said module is changeable and attached to said image formation device, thus the change of different modules is to fit needs of different total tracks. The module has at least one reflection mirror or plural reflection mirrors for one or plural times of reflection of different total tracks.

A main spirit of the present invention is following: an incident angle is equal to an ejective, and a light path of an incident merges with a light path of an ejective in a point, which is on a normal of said incident angle and ejective angle; for instance, a one-time reflection, an incident light is on a reflection element and a reflection point is then generated, said reflection point is a merge point of incident path and ejective path under conditions of two or more reflection times. Referring to FIG. 4, which is the first illustration of technical theory of the present invention. A dotted line A represents an imagine mirror to fit with aforesaid one-time reflection. An incident path 100 and a normal γ form an incident angle α, said incident path 100 touches an X1 point on said imagine mirror A, and then a reflected ejective path 104 and an ejective angle β are formed. Said X1 point is defined merge point thereafter. The following is for two-time reflection: if the imagine mirror A is not existing, a light path 101 is formed after the incident path 100 passing by merge point X1, said light path 101 then touches onto a reflection point X2 of a reflection mirror B, continuously a reflection path 102 goes to a reflection point X3 of a reflection mirror C, and a reflection path 103 passes by merge point X1 to form a path 104 for light leaving here. In the mean time, a normal γ, an incident angle α and an ejective angle β are totally same as said three of the one-time reflection, thus based on the spirit, variable conditions can be altered to increase total track.

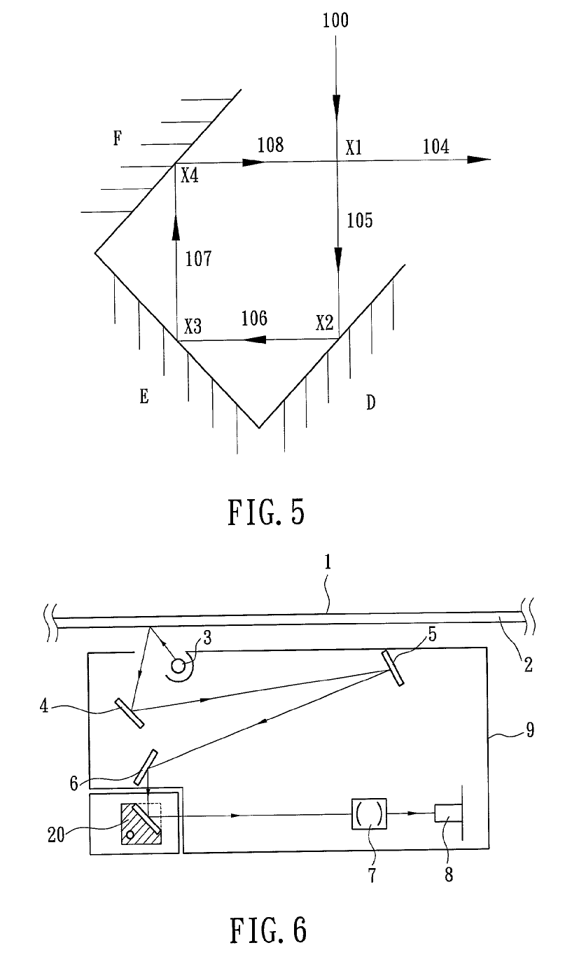

Referring to FIG. 5, which is the second illustration of technical theory of the present invention. Said reflection mirrors B and C in FIG. 4 are separately installed in an optical capturing device, and the present invention collects such reflection elements into a pattern, which means to combine all reflection elements in a body as a module for being fast changed. Following is that how to calculate dimensions of reflection elements for gathering all reflection elements in a pattern: FIG. 5 adopts three-time reflection, and plural predetermined conditions are a direction of incident path 100, a direction of ejective path 104, the merge point X1, a length of total track. Thus, assuming ΔL is a symbol representing an increasing length of total track, and a total length of a light path 105 (a beam X1X2), a light path 106 (a beam X2X3), a light path 107 (a beam X3X4) and a light path 108 (a beam X4X1) is then equal to ΔL; wherein, plural points X2, X3 and X4 are individually reflection points of plural mirrors D, E and F. Said light paths are defined by the direction of incident path 100, and a theory of an incident angle equal to an ejective angle, said predetermined ΔL, said direction of ejective path 104 and said merge point X1 fit each other to gradually derive said light paths 105, 106, 107 and 108. Therefore, dimensions of said reflection mirrors D, E and F are determined, and the module for increasing total track is then generated.

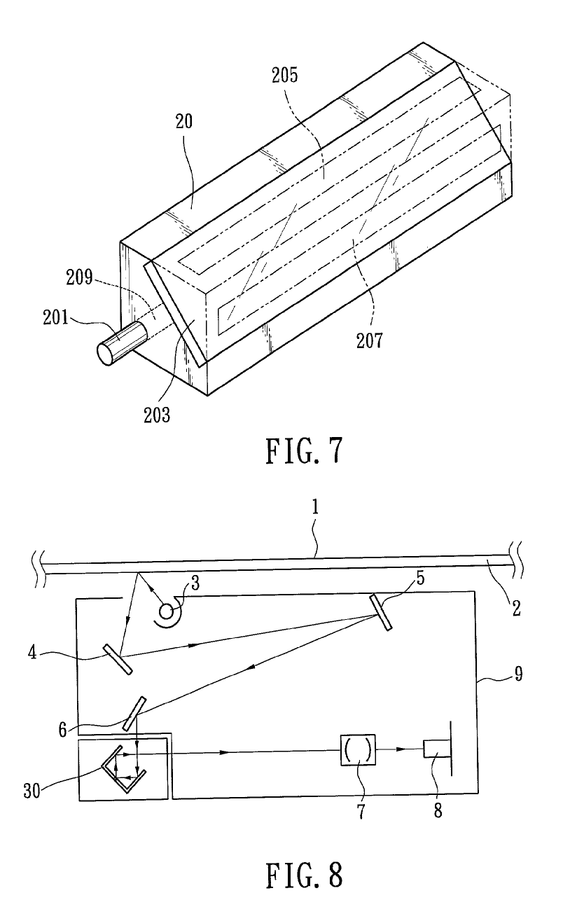

Please refer to FIG. 6, which is a preferred embodiment of a single mirror module of the present invention. Preliminary conditions of not enlarging mirror dimensions and scanner mount are for the embodiment, then adding a single mirror module 20, thus as showing in the figure total track is increased immediately. The single mirror module 20 is independent to scanner mount 9, and this design is to easily change single mirror module 20 to another module. Referring to FIG. 7, which is a 3-D illustration of a single mirror module of the present invention. Single mirror module 20 is cubic, which can be fixed and changed from scanner mount 9 via a buckle apparatus 201, thus different modules can be replaced into scanner mount 9 for different total tracks. Said buckle apparatus 201 is retractable, which can retract a fillister 209 of single mirror module 20, and buckle apparatus 201 can extend into some space in scanner mount 9 for fixing. The fixing for buckle apparatus 201 is same as both sides of single mirror module 20. Single mirror module 20 is axially divided into two parts of a light inlet 205 and a light outlet 207, thus incident light enters to single mirror module 20 via said light inlet 205 and onto an inclined mirror 203, said inclined mirror 203 generates a reflected light path to penetrate said light outlet 207 for light going out. Above description is based on FIGS. 6 and 7. Said mirror 203 is a thin slice and fixed on single mirror module 20 by inclined set-in. Two lengths of two longer sides of mirror 203 are relatively equal to two lengths of two longer sides of single mirror module 20 for mirror 203 being fixed into said cubic body of mirror module 20. An inclined angle for mirror 203 is suitable that the incident angle is equal to the ejective angle; please refer to FIG. 4 for detail.

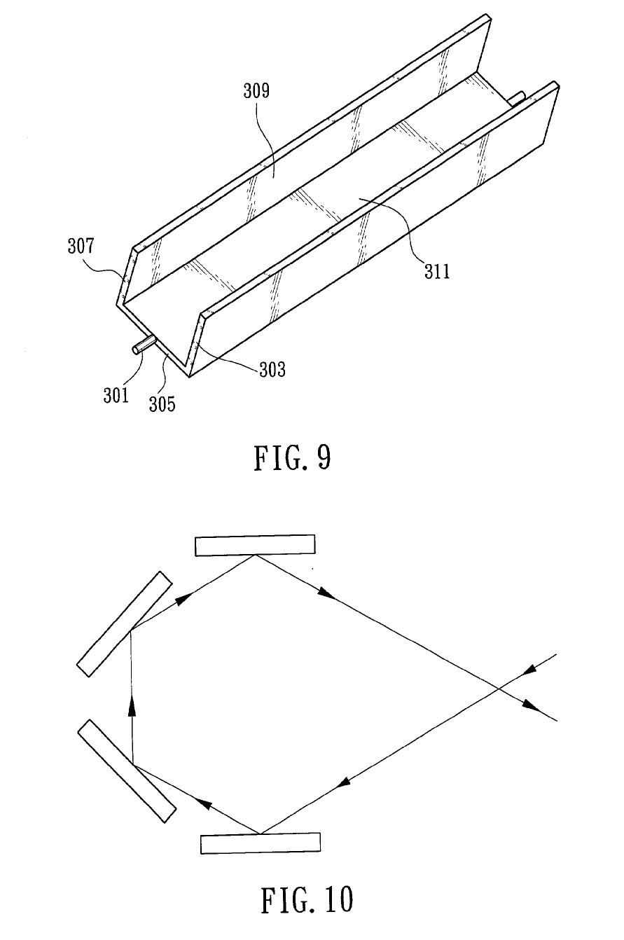

Referring to FIG. 8, which is a preferred embodiment of a 3-mirror module of the present invention. The embodiment is an extended embodiment from FIG. 6. Obviously, the embodiment adopts a three-mirror module, which reflection times is two more than the embodiment of FIG. 6, therefore total track is longer. A three-mirror module 30 of the embodiment is independent and changeable as well. A theory of light paths of the embodiment is same as FIGS. 4 and 5, it is not described again. Referring to FIG. 9, which is a 3-D illustration of a 3-mirror module of the present invention. A buckle apparatus 301 is designed as said buckle apparatus 201 in FIG. 7. A light goes into the three-mirror module 30 via a light inlet 309, then to a first reflection mirror 303, a second reflection mirror 305 and a third reflection mirror 307, continuously light goes out of the module 303 from a light outlet 311.

Referring to FIG. 10, which is a preferred embodiment of a 4-mirror module of the present invention. As aforesaid, the more reflection times the more total track. Therefore, to increase total track as possible as we can and to fast change different modules are the spirit of the present invention for fitting different conditions of total tracks and solutions.

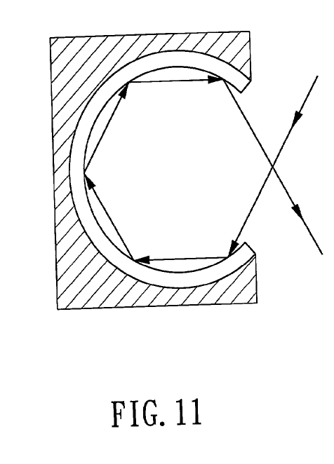

Referring to FIG. 11, which is a preferred embodiment of a round mirror module of the present invention. The embodiment is derived from that a round reflection surface is no difference than reflection mirrors approaching to a critical number, because round reflection surface is able to reflect at any angle. Referring to FIG. 10, if there is an angle of any reflection mirror causing error, reflection is then error, therefore, the embodiment adopts a whole module of a round surface can completely figure out aforesaid problem.

While the present invention has been shown and described with reference to preferred embodiments thereof, and in terms of the illustrative drawings, it should be not considered as limited thereby, for instance, all aforesaid embodiments adopt mirrors as reflection material, and there are other methods making reflection elements, such as general plating or steam coating, and base material for plating or coating can be glass, plastic, metal, etc.; all aforesaid embodiments adopt scanner as optical capturing device, and there are plural products can be instead of scanner, such as copy machine, high solution fax machine, digital camera, video camera, etc. Further, not only one module applied in an optical capturing device, but also plural modules. Thus, the present invention is infinitely used. However, various possible modification, omission, and alterations could be conceived of by one skilled in the art to the form and the content of any particular embodiment, without departing from the scope and the sprit of the present invention.

The invention is disclosed and is intended to be limited only the scope of the appended claims and its equivalent area.

What is claimed is:

1-16. (canceled)

17. An apparatus comprising:
a light source capable of illuminating a light along a light path;
one or more mirrors capable of reflecting the light from the light source;
a lens capable of focusing the light from the one or more mirrors;
an image formation device capable of receiving light from the lens;
an optical capturing device housing;
a first module capable of being removably attachable to the optical capturing device housing, the first module including one or more reflection elements, and wherein the first module and optical capturing device housing have a first total track; and
a second module capable of being removably attachable to the optical capturing device housing, the second module including one or more reflection elements, and wherein the second module and optical capturing device housing have a second total track.

18. The apparatus of claim 17, wherein the first module comprises a buckle capable of being removably attachable to a mount of the optical capturing device housing.

19. The apparatus of claim 18, wherein the buckle is capable of retracting with respect to a body of the first module to removably attach to the mount of the optical capturing device housing.

20. The apparatus of claim 17, wherein the first module is positioned in the light path between the light source and the lens when attached to the optical capturing device housing.

21. The apparatus of claim 17, wherein the first module comprises:
a cubic body, wherein the one or more reflection elements are installed in the cubic body; and
a buckle located in the cubic body capable of being removably attachable to a mount of the optical capturing device housing, the buckle capable of retracting with respect to the cubic body.

22. The apparatus of claim 21, wherein the one or more reflection elements are positioned at a suitable inclined angle in the cubic body, wherein the inclined angle being based on an incident angle being equal to an ejective angle.

23. The apparatus of claim 22, wherein the one or more reflection elements comprise at least two sides being of a same or similar length as corresponding two sides of the cubic body.

24. The apparatus of claim 17, wherein under a condition of incident angle equal to ejective angle and a condition of at least two-time reflection from the one or more reflection elements of the first module, an incident light path merges with an ejective light path in a point on a normal of incident angle and ejective angle; for a condition of one time reflection, incident light path touches onto said reflection element with a reflection point, which is the point of aforesaid incident light path merging with said ejective light path.

25. A method comprising:
in a first mode, scanning an object with a first optical module in a scanning light path at a first total track; and
in a second mode, scanning an object with a second optical module in the scanning light path at a second total track, wherein the second total track is longer than the first total track.

26. The method of claim 25, further comprising reflecting light from a light source via one or more mirrors, and maintaining the one or more mirrors in a fixed position between the first mode and the second mode.

27. An apparatus comprising:
means for scanning an object in a scanning light path at a first total track in a first mode; and
means for scanning an object in the scanning light path at a second total track in a second mode, wherein the second total track is longer than the first total track.

28. The apparatus of claim 27, further comprising means for reflecting light from a light source, and maintaining the means for reflecting light in a fixed position between the first mode and the second mode.
